(19) United States
(12) Patent Application Publication
(10) Pub. No.: US 2016/0226544 A1
(43) Pub. Date: Aug. 4, 2016

(54) ADAPTIVE WIRELESS BASEBAND INTERFACE

(71) Applicant: GM GLOBAL TECHNOLOGY OPERATIONS LLC, DETROIT, MI (US)

(72) Inventors: TIMOTHY J. TALTY, BEVERLY HILLS, MI (US); ALEJANDRO H. PLAZAS TORRES, LAKE ORION, MI (US); MARY L. MAYER, NORTHVILLE, MI (US); JAMES CHINGWEI LI, SIMI VALLEY, CA (US); YEN-CHENG KUAN, LOS ANGELES, CA (US)

(21) Appl. No.: 15/010,768

(22) Filed: Jan. 29, 2016

Related U.S. Application Data
(60) Provisional application No. 62/112,023, filed on Feb. 4, 2015.

(51) Int. Cl. H04B 1/3822; H04B 1/00

(52) U.S. Cl. CPC H04B 1/3822; H04B 1/0028

(57) ABSTRACT

A wireless communications device that includes a digital front end module (FEM) that provides digital receive signals to a baseband processor and receives digital transmit signals from the baseband processor. The baseband processor can be an existing baseband processor for wireless communications devices that employ an analog FEM that includes an ADC for converting analog receive signals to digital signals for baseband processing and a DAC for converting digital transmit signals to analog signals, where the ADC and the DAC are not used.

### CROSS-REFERENCE TO RELATED APPLICATIONS

This application claims the benefit of the priority date of U.S. Provisional Patent Application Ser. No. 62/112,023, titled, Adaptive Wireless Baseband Interface, filed Feb. 4, 2015.

### BACKGROUND OF THE INVENTION

1. Field of the Invention

This invention relates generally to a wireless communications device having RF and signal processing elements, and including an adaptive interface for digital signal transfer between a digital front end module (FEM) and a baseband processor and, more particularly, to a wireless communications device having RF and signal processing elements, and including an adaptive interface for digital signal transfer between a digital FEM and a baseband processor, where the interface by-passes a currently existing analog-to-digital converter (ADC) and a digital-to-analog converter (DAC) in the processor or provides signal flow between the digital FEM and a high speed I/O port on the baseband processor.

2. Discussion of the Related Art

A conventional wireless communications device, such as a cellular telephone, generally will include an analog front end module (FEM) in which analog RF signal processing is performed for both signals received by the device and signals transmitted by the device. Thus, the analog FEM will include processing elements for analog signals received by the device, such as a low noise amplifier (LNA), band-pass filters, RF down-conversion circuits, etc. Likewise, the analog FEM will include processing elements for analog signals transmitted by the device, such as RF up-conversion circuits, band-pass filters, high power amplifiers (HPA), etc.

A conventional wireless communications device will generally also include a baseband processor that receives the analog receive signals from the analog FEM and that sends the analog transmit signals to the analog FEM. The baseband processor includes an analog-to-digital converter (ADC) and a digital-to-analog converter (DAC) to perform the conversion from analog to digital for the receive signals and the conversion from digital to analog for the transmit signals. The baseband processor will also include the necessary digital circuit elements for message recovery and de-modulation of the receive signal, and signal processing for various signals such as audio or video messages.

A conventional wireless communications device will generally also include an application processor that is the interface between the user of the device and the baseband processor. For example, the application processor may include software and circuits for converting inputs, such as text and audio signals, from the user to a suitable digital signal to be processed by the baseband processor, and will receive the digital messages recovered by the baseband processor, and convert the messages to the appropriate format to be understood by the user.

Digital software-defined radio architectures exist in the art, such as in certain military radios having multi-band waveforms. The current trend is to provide such digital software-defined radio architectures for automotive applications, which necessarily would need to be much lower cost than military radios. Such wireless communications devices that are configured to operate in the digital domain typically would include a digital FEM that provides flexibility and software definable processing, and a baseband processor that operates exclusively in the digital domain and be able to receive digital signals from the FEM and send digital signals to the FEM for transmission purposes. In these designs, the analog-to-digital conversion for the receive signals and the digital-to-analog conversion for the transmit signals is performed in the digital FEM.

### SUMMARY OF THE INVENTION

The present disclosure describes a wireless communications device that includes a digital FEM that provides digital receive signals to a baseband processor and receives digital transmit signals from the baseband processor. The baseband processor can be an existing baseband processor for mobile wireless devices that employ an analog FEM that includes an ADC for converting analog receive signals to digital signals for baseband processing and a DAC for converting digital transmit signals to analog signals. In a first embodiment, the ADC and the DAC in the existing baseband processor operate as a signal pass-through, where digital transmit signals from the baseband processor pass directly through the DAC to the digital FEM and digital receive signals from the digital FEM pass directly through the ADC to other digital components within the baseband processor. In a second embodiment, the digital receive signals from the digital FEM by-pass the ADC in the baseband processor and the digital transmit signals from the baseband processor to the digital FEM bypass the DAC. In a third embodiment, digital receive signals from the digital FEM are provided to an existing digital I/O port in the baseband processor and digital transmit signals from the baseband processor are provided from a digital I/O port to the digital FEM.

Additional features of the present invention will become apparent from the following description and appended claims, taken in conjunction with the accompanying drawings.

### BRIEF DESCRIPTION OF THE DRAWINGS

FIG. 1 is schematic block diagram of a wireless communications device including a conventional baseband processor and a digital FEM; and

FIG. 2 is a schematic block diagram of a wireless communications device including a baseband processor, where an ADC and a DAC have been removed.

### DETAILED DESCRIPTION OF THE EMBODIMENTS

The following discussion of the embodiments of the invention directed to a wireless communications device including a digital FEM and a conventional baseband processor is merely exemplary in nature, and is in no way intended to limit the invention or its applications or uses. For example, the discussion herein has particular application for a wireless mobile communications device on a vehicle. However, as will be appreciated by those skilled in the art, the wireless mobile communications device of the invention well have other applications.

As will be discussed in detail below, the present invention proposes a wireless communications device including a digital FEM and a conventional baseband processor having a known configuration typically being employed in a wireless communications device having an analog FEM of the type discussed above. As will be discussed, operation of the baseband processor will be re-configured so that digital receive signals from the digital FEM are able to be processed by the baseband processor and digital transmit signals provided by the baseband processor are sent to the digital FEM, thus eliminating the need for significant redesign of the conventional baseband processor for the digital FEM. The wireless communications device can be any such device, such as a cellular device, cognitive radio, TV whitespace devices, etc.

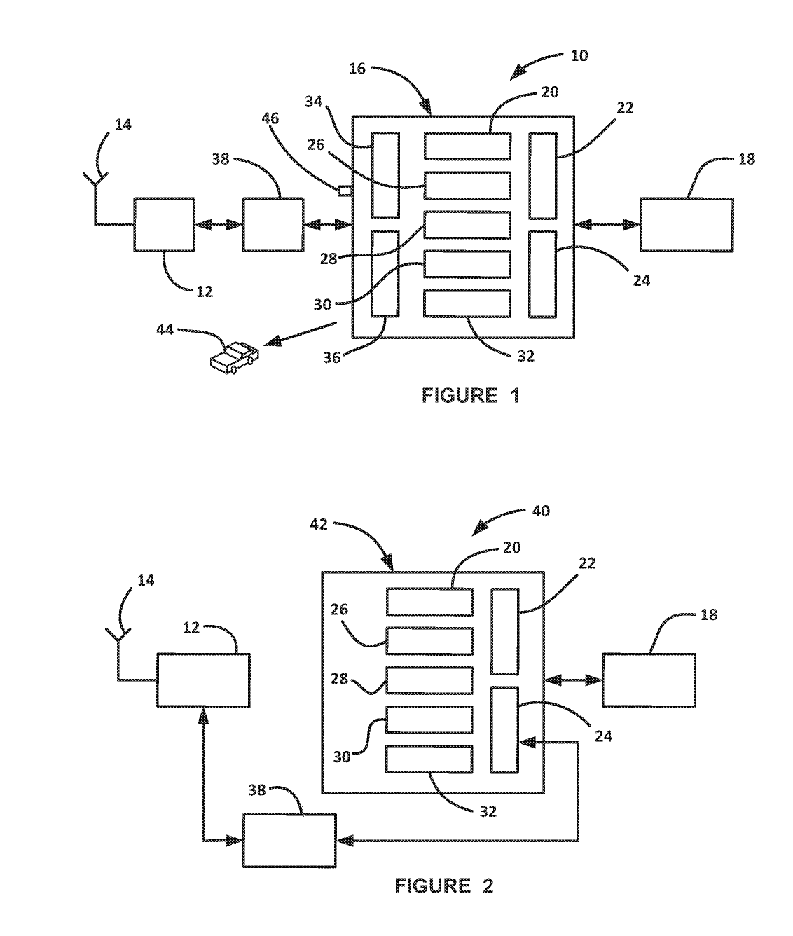

FIG. 1 is a schematic block diagram of a wireless communications device 10 that is able to process both transmit signals and receive signals, such as cellular signals. The device 10 can be any device, such as a hand-held mobile unit or a wireless device, such as a radio, on a vehicle 44. The device 10 includes a digital FEM 12 that provides digital signal processing for the transmit and receive signals, where analog receive signals are received by an antenna 14 and analog transmit signals are transmitted by the antenna 14. The digital FEM 12 includes any suitable and all necessary analog and digital front end processing circuitry for a wireless device, such as band-pass filters, circulators for isolating the receive and transmit signals, down-converters, up-converters, switches, modulators, DACs, ADCs, low noise amplifiers, power amplifiers, etc.

The device 10 also includes a baseband processor 16 of the type discussed above that provides data recovery, power conditioning, signal modulation, signal de-modulation, etc. The communications device 10 also includes an application processor 18 that receives the receive signals from the baseband processor 16 and provides signals to be transmitted to the baseband processor 16, where the application processor 18 provides a control interface between the baseband processor 16 and the user, as also discussed above.

The baseband processor 16 is of a conventional type, and includes a central processing unit (CPU) 20 that performs basic digital functions in the processor 16, such as clocking functions, message scheduling functions, etc. The baseband processor 16 also includes a modulator 26 that provides digital signal modulation for the transmit signal, and a de-modulator 28 for de-modulating the receive signal to remove information and message bits therefrom. The baseband processor 16 also includes a memory 30 for storing the digital bits to be transmitted or received, and a power management circuit 32 for providing power management and conditioning. The baseband processor 16 also includes a host computer 22 that runs the various application levels in the processor 16 and provides signal transformation for an interface to the application processor 18. Further, the baseband processor 16 includes an interface 24 intended to represent the many input/output (I/O) ports coupled to the baseband processor 16, such as USB ports, that allow other electronic devices (not shown) to be coupled thereto to provide, for example, software updating, software down-loading, testing, etc.

Further, since the baseband processor 16 is of a conventional type that would normally be used with an analog FEM (not shown) as discussed above, the baseband processor 16 includes an ADC 34 that converts analog receive signals from the analog FEM to digital signals to be processed by the digital components of the baseband processor 16, and a DAC 36 that converts digital signals processed by the baseband processor 16 to analog signals to be sent to the analog FEM for transmission in the known devices. In the embodiments discussed herein where the analog FEM has been replaced with the digital FEM 12, and where the digital FEM 12 provides analog to digital conversion and digital to analog conversion, the already existing ADC 34 and DAC 36 in the processor 16 are not used.

In a first embodiment, the ADC 34 and the DAC 36 only operate as pass-through elements in the processor 16 and do not provide any digital and analog signal conversion. For example, the digital signals to be transmitted may have been sent from the modulator 26 to the DAC 36 in the device employing an analog FEM to convert the digital signals to analog signals for transmission. However, in this embodiment, the digital transmit signals are still provided to the DAC 36, but the DAC 36 is re-configured so that it outputs the same digital signal that it receives. Thus, the modulated digital signals from the modulator 26 are sent directly to the digital FEM 12 where they are converted to an analog signal for transmission. Likewise, in the analog FEM design, the ADC 34 may have converted the analog signals from the analog FEM to digital signals that would then be provided to the de-modulator 28 to remove the bits. However, in this embodiment, the digital receive signals are provided to the ADC 34 directly from the FEM 12, where the ADC 34 is reconfigured so that it outputs the same digital signal that it receives from the digital FEM 12, where the analog signals received by the antenna 14 are converted to the digital signals in the FEM 12.

In another embodiment, the baseband processor 16 can be re-configured so that the digital receive signals from the digital FEM 12 completely by-pass the ADC 34, such as through a test port 46, and be directly sent to the de-modulator 28. Likewise, the baseband processor 16 can be re-configured so that the transmit signals from the modulator 26 completely by-pass the DAC 36 and be provided directly to the digital FEM 12, such as through the test port 46, as digital signals.

FIG. 2 is a schematic block diagram of a wireless communications device 40 that is similar to the wireless device 10, where like elements are identified by the same reference number. In this embodiment, the baseband processor 16 has been replaced with a baseband processor 42, where the ADC 34 and DAC 36 have been eliminated to specifically show that they are not used in the device 40, although they still may be present in the baseband processor 42 if it is an already existing device that could be used in connection with an analog FEM. In this embodiment, the digital receive signals from the digital FEM 12 are provided to one or more of the interface I/O ports 24 in the baseband processor 42 and the digital transmit signals from the baseband processor 42 are provided to the digital FEM 12 from one of the interface I/O ports 24. The I/O ports 24 would route the digital receive signals from the digital FEM 12 to the de-modulator 28 and the transmit signals from the modulator 26 would be sent to the interface I/O port 24 to be sent to the digital FEM 12.

For certain communications devices there may be a need to provide additional signal conditioning and/or formatting between the digital FEM 12 and the baseband processor 16 or 42 depending on the capabilities and signal requirements of the FEM 12 and the baseband processor 16 or 42. The additional signal conditioning can be accomplished by including one or more dedicated circuits between the FEM 12 and the baseband processor 16 or 42, such as a digital signal processing (DSP) chip. For example, the circuit could provide digital signal formatting, such as converting digital signals from serial to parallel, formatting signals, converting digital formats, such as USB, SPI, etc., and/or scaling the signal to appropriate time and amplitude scales. For the embodiments discussed above, a dedicated circuit or chip 38 can be provided between the FEM 12 and the baseband processor 16 or 42 to perform one or more of these functions.

As will be well understood by those skilled in the art, the several and various steps and processes discussed herein to describe the invention may be referring to operations performed by a computer, a processor or other electronic calculating device that manipulate and/or transform data using electrical phenomenon. Those computers and electronic devices may employ various volatile and/or non-volatile memories including non-transitory computer-readable medium with an executable program stored thereon including various code or executable instructions able to be performed by the computer or processor, where the memory and/or computer-readable medium may include all forms and types of memory and other computer-readable media.

The foregoing discussion discloses and describes merely exemplary embodiments of the present invention. One skilled in the art will readily recognize from such discussion and from the accompanying drawings and claims that various changes, modifications and variations can be made therein without departing from the spirit and scope of the invention as defined in the following claims.

What is claimed is:

1. A wireless communications device comprising:
a digital front end module (FEM) that converts digital transmit signals to analog transmit signals to be transmitted and converts analog receive signals that are received by the FEM to digital receive signals; and
a baseband processor providing the digital transmit signals to the digital FEM and receiving the digital receive signals from the digital FEM, said digital receive signals from the digital FEM by-passing an analog-to-digital converter (ADC) in the baseband processor and said digital transmit signals by-passing a digital-to-analog converter (DAC) in the baseband processor.

2. The device according to claim 1 wherein the receive signals and the transmit signals by-pass the ADC and the DAC through a test port.

3. The device according to claim 1 wherein the baseband processor includes a modulator for modulating the digital transmit signals and a de-modulator for demodulating the digital receive signals.

4. The device according to claim 1 further comprising a dedicated circuit that receives the transmit signals from the baseband processor and provides the transmit signals to the FEM and receives the receive signals from the FEM and provides the receive signals to the baseband processor, said dedicated circuit providing one or more of signal conditioning, signal formatting, converting digital signals from serial to parallel, converting digital formats, and scaling signals to appropriate time and amplitude scales.

5. The device according to claim 4 wherein the dedicated circuit is a digital signal processing chip.

6. The device according to claim 1 wherein the device is a hand-held mobile unit or a wireless communications device on a vehicle.

7. The device according to claim 1 wherein the device is a radio on a vehicle.

8. A wireless communications device comprising:
a digital front end module (FEM) that converts digital transmit signals to analog transmit signals to be transmitted and converts analog receive signals received by the FEM to digital receive signals; and
a baseband processor providing the digital transmit signals to the digital FEM and receiving the digital receive signals from the digital FEM, said digital receive signals from the digital FEM passing through an analog-to-digital converter (ADC) in the baseband processor as digital signals without being converted and the digital transmit signals passing through a digital-to-analog converter (DAC) in the baseband processor as digital signals without being converted.

9. The device according to claim 8 wherein the baseband processor includes a modulator for modulating the digital transmit signals and a de-modulator for demodulating the digital receive signals.

10. The device according to claim 8 further comprising a dedicated circuit that receives the transmit signals from the baseband processor and provides the transmit signals to the FEM and receives the receive signals from the FEM and provides the receive signals to the baseband processor, said dedicated circuit providing one or more of signal conditioning, signal formatting, converting digital signals from serial to parallel, converting digital formats, and scaling signals to appropriate time and amplitude scales.

11. The device according to claim 10 wherein the dedicated circuit is a digital signal processing chip.

12. The device according to claim 8 wherein the device is a hand-held mobile unit or a wireless communications device on a vehicle.

13. The device according to claim 8 wherein the device is a radio on a vehicle.

14. A wireless communications device comprising:
a digital front end module (FEM) that converts digital transmit signals to analog transmit signals to be transmitted and converts analog receive signals to digital receive signals; and
a baseband processor providing the digital transmit signals to the digital FEM and receiving the digital receive signals from the digital FEM, said baseband processor including high speed interface input/output (I/O) ports, wherein the digital transmit signals are provided to the digital FEM through the I/O ports and the digital receive signals are received from the digital FEM through the I/O ports.

15. The device according to claim 14 wherein the baseband processor includes a modulator for modulating the digital transmit signals and a de-modulator for demodulating the digital receive signals.

16. The device according to claim 14 further comprising a dedicated circuit that receives the transmit signals from the baseband processor and provides the transmit signals to the FEM and receives the receive signals from the FEM and provides the receive signals to the baseband processor, said dedicated circuit providing one or more of signal conditioning, signal formatting, converting digital signals from serial to parallel, converting digital formats, and scaling signals to appropriate time and amplitude scales.

17. The device according to claim 16 wherein the dedicated circuit is a digital signal processing chip.

18. The device according to claim 14 wherein the device is a hand-held mobile unit or a wireless communications device on a vehicle.

19. The device according to claim 14 wherein the device is a radio on a vehicle.

20. A wireless communications device comprising:
a digital front end module (FEM) that converts digital transmit signals to analog transmit signals to be transmitted and converts analog receive signals that are received by the FEM to digital receive signals; and
a baseband processor providing the digital transmit signals to the digital FEM and receiving the digital receive signals from the digital FEM, said baseband processor including an analog-to-digital converter (ADC), a digital-to-analog converter (DAC) and input/output (I/O) ports.
